(19) United States
(12) Patent Application Publication
(10) Pub. No.: US 2024/0297706 A1
(43) Pub. Date: Sep. 5, 2024

(54) TERMINAL, RADIO COMMUNICATION SYSTEM AND RADIO COMMUNICATION METHOD

(71) Applicant: NTT DOCOMO, INC., Tokyo (JP)

(72) Inventors: Yuki Matsumura, Tokyo (JP); Shohei Yoshioka, Tokyo (JP); Satoshi Nagata, Tokyo (JP)

(73) Assignee: NTT DOCOMO, INC., Tokyo (JP)

(21) Appl. No.: 18/573,081

(22) PCT Filed: Jun. 25, 2021
(86) PCT No.: PCT/JP2021/024165

§ 371 Date: Dec. 21, 2023

(51) Int. Cl. H04B 7/06; H04L 5/00; H04W 76/20

(52) U.S. Cl. CPC H04B 7/06968; H04L 5/0051; H04W 76/20

(57) ABSTRACT

A terminal receives a first downlink reference signal and a second downlink reference signal, and assumes that the first downlink reference signal is a quasi-colocation with the second downlink reference signal when receiving the first downlink reference signal in a state in which a connection at a given layer is not established.

### TECHNICAL FIELD

The present disclosure relates to a terminal, a radio communication system and a radio communication method for receiving a downlink reference signal.

### BACKGROUND ART

3rd Generation Partnership Project (3GPP) specifies 5th generation mobile communication system (5G, also called New Radio (NR) or Next Generation (NG), further, a succeeding system called Beyond 5G, 5G Evolution or 6G is being specified.

In Release 15 and 16 of the 3GPP, in order for a terminal (User Equipment, UE) to receive a physical downlink channel, specifically, a PDSCH (Physical Downlink Shared Channel) and a PDCCH (Physical Downlink Control Channel), the TCI (Transmission Configuration Indication) state is indicated to the UE from the network.

The TCI state can explicitly indicate a quasi-colocation (QCL) relationship between a given downlink reference signal (DL-RS) and PDSCH/PDCCH. The type of QCL is defined by parameters such as Doppler shift and average delay that indicate the channel state (channel condition) (Non-Patent Literature 1).

Before establishing a radio resource control layer (RRC) connection (which may include idle or inactive states), the UE may assume that the PDSCH/PDCCH are QCLed with a synchronization signal block (SSB (Synchronization Signal)/PBCH (Physical Broadcast CHannel) Block).

### CITATION LIST

### Non-Patent Literature

### [Non-Patent Literature 1]

3GPP TS 38.214 V 16.5.0, 3rd Generation Partnership Project; Technical Specification Group Radio Access Network; NR; Physical layer procedures for data (Release 16), 3GPP, March 2021

### SUMMARY OF INVENTION

As described above, before the RRC connection, the PDSCH/PDCCH, specifically demodulation reference signal (DMRS) of PDSCH/PDCCH, may be assumed to be QCLed with SSB, but there is room for improvement in the DMRS reception characteristics of the UE.

Specifically, if the tracking reference signal (TRS) or the channel state information-reference signal (CSI-RS), which have a larger resource element (RE) and transmission band than the SSB, can be used before the RRC connection is established, more accurate measurement of the channel state can be expected.

However, since the TCI state can be indicated after the RRC connection, the QCL relationship cannot be indicated by the TCI state before the RRC connection. Therefore, there is no way for the UE to recognize the the DMRS that is QCLed with TRS/CSI-RS before the RRC connection.

Therefore, the following disclosure has been made in view of this situation, and the purpose of the disclosure is to provide the terminal, radio communication system, and radio communication method can realize more accurate measurement of the channel state even before the RRC connection.

An aspect of the present disclosure is a terminal (UE200) including a reception unit (control signal and reference signal processing unit 240) that receives a first downlink reference signal and a second downlink reference signal; and a control unit (control unit 270) that assumes that the first downlink reference signal is a quasi-colocation with the second downlink reference signal when receiving the first downlink reference signal in a state in which a connection at a given layer is not established.

An aspect of the present disclosure is a radio communication system including a radio base station and a terminal. The radio base station includes a transmission unit that transmits a first downlink reference signal and a second downlink reference signal. The terminal includes a reception unit that receives the first downlink reference signal and the second downlink reference signal, and a control unit that assumes that the first downlink reference signal is a quasi-colocation with the second downlink reference signal when receiving the first downlink reference signal in a state in which a connection at a given layer is not established.

An aspect of the present disclosure is a radio communication method including the steps of: receiving at a terminal a first downlink reference signal and a second downlink reference signal, and assuming at the terminal that the first downlink reference signal is a quasi-colocation with the second downlink reference signal when receiving the first downlink reference signal in a state in which a connection at a given layer is not established.

### BRIEF DESCRIPTION OF DRAWINGS

FIG. 1 is an overall schematic diagram of a radio communication system 10.

FIG. 2 is a diagram showing a configuration example of a radio frame, a sub-frame and a slot used in the radio communication system 10.

FIG. 3 is a diagram showing an example of configuring the TCI state field of DCI format 1_1/1_2.

FIG. 4 is a functional block diagram of a gNB100 and a UE200.

FIG. 5 is a diagram showing an example sequence of the initial access procedure specified by 3GPP Releases 15 and 16.

FIG. 6 is a diagram showing a configuration example of an SSB and a RACH Occasion (RO)/RAR window (with beam correspondence).

FIG. 7 is a diagram showing an example of the configuration of the SSB and the RACH Occasion (RO)/RAR window (without beam correspondence).

FIG. 8 is a diagram showing an operation example of beam determination before RRC connection.

FIG. 9 is a diagram showing an operation example of beam determination after RRC connection.

FIG. 10 is a diagram showing an example of the transmission sequence of the DL-RS according to the operation example 1.

FIG. 11 is a diagram showing an operation example of beam determination according to the operation example 2-1.

FIG. 12 is a diagram showing an operation example of beam determination according to the operation example 2-2.

FIG. 13 is a diagram showing an operation example of beam determination according to the operation example 3.

FIG. 14 is a diagram showing an example of the correspondence relationship between the SSB/TRS and the MBS PDSCH/PDCCH Occasion according to the operation example 3.

FIG. 15 is a diagram showing an instruction example of TCI state/QCL information according to the operation example 4.

FIG. 16 is a diagram showing an example of a resource candidate according to the operation example 4.

FIG. 17 is a diagram showing an example of a hardware configuration of the gNB100 and the UE200.

### MODES FOR CARRYING OUT THE INVENTION

Exemplary embodiments of the present invention are explained below with reference to the accompanying drawings. Note that, the same or similar reference numerals have been attached to the same functions and configurations, and the description thereof is appropriately omitted.

### (1) Overall Schematic Configuration of the Radio Communication System

### (1.1) Example of a System Configuration

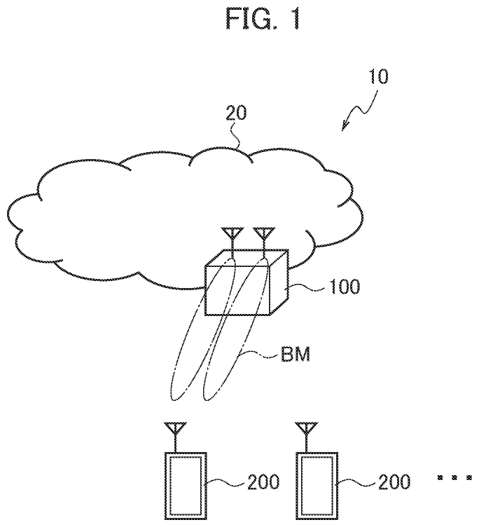

FIG. 1 is an overall schematic configuration diagram of the radio communication system 10 according to the present embodiment. The radio communication system 10 is a radio communication system according to 5G New Radio (NR) and includes a Next Generation-Radio Access Network 20 (hereinafter NG-RAN20 and a plurality of terminals 200 (User Equipment 200, UE200).

The radio communication system 10 may be a radio communication system according to a system called Beyond 5G, 5G Evolution or 6G.

The NG-RAN20 includes a radio base station 100 (gNB100). The specific configuration of the radio communication system 10 including the number of gNBs and UEs is not limited to the example shown in FIG. 1.

The NG-RAN20 actually includes a plurality of NG-RAN Nodes, specifically gNBs (or ng-eNBs), connected to a core network (5GC, not shown) according to 5G. Note that the NG-RAN20 and 5 GCs may be referred to simply as “network”.

The gNB100 is a radio base station according to the NR and performs radio communication with the UE200 according to the NR. The gNB100 and the UE200 can support Massive MIMO, which generates a more directional beam BM by controlling radio signals transmitted from a plurality of antenna elements, Carrier Aggregation (CA), which uses a plurality of component carriers (CCs) bundled together, and Dual Connectivity (DC), which simultaneously communicates between the UE and each of a plurality of NG-RAN Nodes.

The radio communication system 10 supports FR1 and FR2. The frequency band of each FR (Frequency Range) is as follows.
FR1: 410 MHz˜7.125 GHz
FR2: 24.25 GHz˜52.6 GHz

FR1 uses sub-carrier spacing (SCS) of 15, 30 or 60 kHz and may use a bandwidth (BW) of 5˜100 MHz. FR2 is higher frequency than FR1 and may use SCS of 60 or 120 kHz (may include 240 kHz) and may use a bandwidth (BW) of 50˜400 MHz.

In addition, the radio communication system 10 may support a higher frequency band than the frequency band of the FR2. Specifically, the radio communication system 10 may support a frequency band greater than 52.6 GHz and up to 114.25 GHz. the radio communication system 10 may also support a frequency band between FR1 and FR2.

Cyclic Prefix-Orthogonal Frequency Division Multiplexing (CP-OFDM)/Discrete Fourier Transform-Spread (DFT-S-OFDM) with greater Sub-Carrier Spacing (SCS) may also be applied. Furthermore, DFT-S-OFDM may be applied not only to the uplink (UL) but also to the downlink (DL).

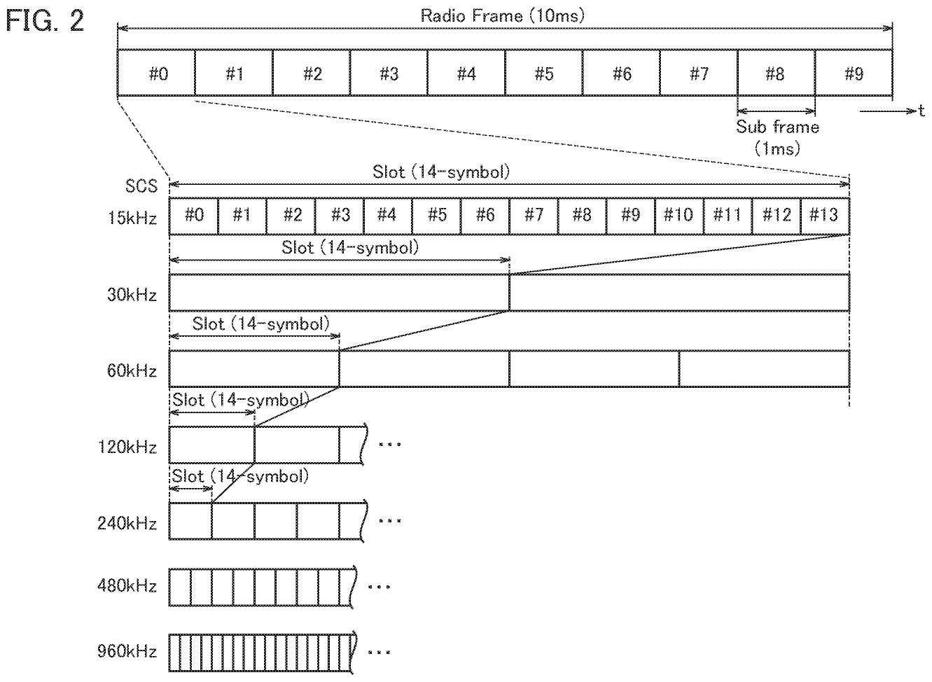

FIG. 2 shows a configuration example of a radio frame, subframe and slot used in the radio communication system 10.

As shown in FIG. 2, 1 slot is composed of 14 symbols, and the larger (wider) the SCS, the shorter the symbol period (and slot period). Note that the number of symbols constituting 1 slot may not necessarily be 14 symbols (For example, 28, 56 symbols). The number of slots per subframe may vary depending on the SCS. In addition, the SCS may be wider than 240 kHz (For example, as shown in FIG. 2, 480 kHz, 960 kHz).

Note that the time direction (t) shown in FIG. 2 may be referred to as a time domain, symbol period, symbol time, etc. The frequency direction may be referred to as a frequency domain, resource block, resource block group, subcarrier, BWP (Bandwidth part), subchannel, common frequency resource, etc.

### (1.2) QCL/TCI State

Quasi-colocation (QCL) means that, for example, if the characteristics of the channel through which symbols are carried on one antenna port can be inferred from the channel through which symbols are carried on the other antenna port, the two antenna ports are located in the same pseudo location.

Furthermore, it can be interpreted that a QCL should be assumed between SSBs (Synchronization Signal/Physical Broadcast Channel blocks) with the same SSB index, and a QCL should not be assumed between other SSBs (i.e., different SSB indices). A QCL may be called a pseudo-colocation.

In order to receive a PDSCH (Physical Downlink Shared Channel) or PDCCH (Physical Downlink Control Channel) demodulation reference signal (DMRS), a TCI (Transmission Configuration Indication) state is configured in the NR (If not configured, it can be a QCL relationship with the SSB index of recent PRACH (Physical Random Access Channel) transmissions).

The TCI state may mean that it is explicitly configured and instructed by the radio resource control layer (RRC) or a control element (MAC CE) of the medium access control layer (MAC). The QCL relationship may include both cases where the TCI state is explicitly configured and cases where the TCI state is not configured. The QCL/TCI state/beam may be interchanged.

For example, when the Physical Downlink Control Channel (PDCCH) is pseudo-collocated with the SSB (QCLed), it can be interpreted that the PDCCH has passed through a channel state similar to that of the SSB (channel state, channel condition). In other words, when the DMRS of the PDCCH and the SSB (as well as other RSs) are QCLs, it can be interpreted that both (signals of) the PDCCH and the SSB have reached the receiver through a fairly similar channel state. Therefore, the channel estimation information for detecting the SSB is also useful for detecting the PDCCH.

Here, the channel state may be defined by the following parameters.
Doppler shift
Doppler spread
Average delay
Delay spread
spatial Rx parameter

Such a parameter may also be used to define the QCL type. Specifically, the QCL type is defined in Section 5.1.5 of 3GPP TS38.214 as follows:
QCL-Type A: {Doppler shift, Doppler spread, average delay, delay spread}
QCL-Type B: {Doppler shift, Doppler spread}
QCL-Type C: {Doppler shift, average delay}
QCL-Type D: {Spatial Rx parameter}

Type A is always configured as the TCI state of the DMRS of PDCCH/PDSCH, and in addition, Type D may be configured (especially for FR2).

Type A RS (CSI (Channel State Information)-RS) is used for long-term channel state measurement and may be utilized, for example, for channel estimation of DMRS. Since only instantaneous measurements can be obtained by measuring DMRS, Doppler information and the like cannot be obtained. The UE200 obtains QCL-Type A (Doppler shift, Doppler spread, average delay, delay spread) information by measuring periodic RS (For example, TRS (Tracking Reference Signal)) configured as QCL Type A RS in advance, and receives PDCCH/PDSCH using these information.

Type D RS is used to notify the base station side transmission spatial domain filter (in short, analog beam). The UE200 selects an appropriate UE-side reception spatial domain filter by measuring the RS (For example, TRS) previously configured as Type D RS, and receives PDCCH/PDSCH using the reception spatial domain filter when receiving PDCCH/PDSCH.

The TCI state of PDCCH may be notified by the RRC and/or MAC CE. Up to eight TCI states of PDSCH may be notified by the RRC/MAC CE and may be indicated by Downlink Control Information (DCI), specifically a TCI state field of up to three bits in DCI format 1_1/1_2 (present if the RRC tciPresentInDCI is configured).

If the time between DCI and PDSCH is less than timeDurationForQCL (described in detail below), the TCI state of PDSCH may be determined by a predetermined method. If DCI format 1_1/1_2 and tciPresentInDCI is not configured, the TCI state of PDSCH may be determined by a predetermined method because there is no TCI state field.

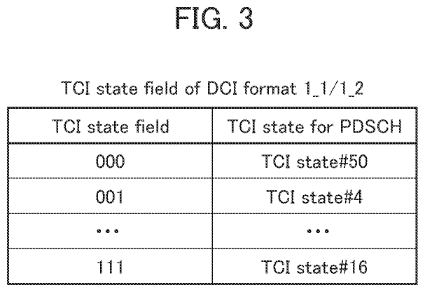

FIG. 3 shows an example of configuring the TCI state field of DCI format 1_1/1_2. As shown in FIG. 3, a 3-bit TCI state field may be assigned. The value of the TCI state field may be associated with the TCI state for a given PDSCH.

In DCI format 1_0, since there is no TCI state field in the first place, the TCI state of the PDSCH may be determined by a given method. Such a given method may be called the Default TCI state.

It is particularly expected that multicast PDSCH (MBS PDSCH) schedules use DCI format 1_0.

The QCL of PDCCH (DCI) that scheduled PDSCH may be assumed to be the QCL of PDSCH.

### (1.3) Provision of MBS

The radio communication system 10 may provide Multicast and Broadcast Services (MBS).

For example, in a stadium or hall, a large number of UE200s may be located in a certain geographic area and a large number of UE200 s may simultaneously receive the same data. In such a case, the use of MBS rather than unicast is effective.

Unicast may be interpreted as communication performed one-to-one with the network by specifying a specific UE200 (identification information specific to the UE200 may be specified).

Multicast may be interpreted as communication performed one-to-many (many specified) with the network by specifying a specific plurality of UE200 (identification information for multicast may be specified). As a result, the number of UE200 that receive the received multicast data may be 1.

The broadcast may be interpreted as a communication between all UE200 and the network in an unspecified number. The multicast/broadcast data may have the same copied content, but some content, such as headers, may be different. The multicast/broadcast data may also be transmitted (distributed) simultaneously, but does not necessarily require strict concurrency, and may include propagation delays and/or processing delays within the RAN node.

The target UE200 may be in an idle state (RRC idle), a connected state (RRC connected), or any other state (For example, the inactive state) in the radio resource control layer (RRC). The inactive state may be interpreted as a state in which some configurations of the RRC are maintained.

MBS assumes the following three methods for scheduling multicast/broadcast PDSCH, specifically scheduling MBS packets (which may be read as data). RRC connected UE may be read as RRC idle UE or RRC inactive UE.

### PTM Transmission Method 1 (PTM-1):

Schedule group-common PDSCH with group-common PDCCH for MBS group of RRC connected UE.
The cyclic redundancy checksum (CRC) of PDCCH and PDSCH are scrambled by group-common RNTI (Radio Network Temporary Identifier).

### PTM Transmission Method 2 (PTM-2):

Schedule a group-common PDSCH with a terminal-specific PDCCH for the MBS group of the RRC connected UE.
The CRC of the PDCCH is scrambled by the UE-specific RNTI.
The PDSCH is scrambled by the group-common RNTI.

### PTP Transmission Method:

Schedule UE-specific PDSCH with UE-specific PDCCH for RRC connected UE.
CRC of PDCCH and PDSCH are scrambled by UE-specific RNTI. This may mean that MBS packets are transmitted by unicast.

In order to improve the reliability of MBS, the following two feedback methods are assumed for HARQ (Hybrid Automatic repeat request) feedback, specifically, HARQ feedback for multicast/broadcast PDSCH.

### Option 1: Feedback of Both ACK and NACK (ACK/NACK Feedback)

A UE that successfully receives or decrypts PDSCH transmits an ACK
A UE that fails to receive or decrypt PDSCH transmits a NACK
PUCCH (Physical Uplink Control Channel) resource configuration: PUCCH-Config can be configured for multicast
PUCCH resource: Shared/orthogonal between UEs depends on the network configuration
HARQ-ACK CB (codebook): supports type-1 and type-2 (CB decision algorithm specified in 3GPP TS 38.213)
Multiplexing: can apply unicast or multicast

### Option 2: NACK-Only Feedback

A UE that successfully receives or decrypts PDSCH does not transmit an ACK (does not transmit a response)
A UE that fails to receive or decrypt PDSCH transmits a NACK
For a given UE, PUCCH resource configuration can be configured separately by unicast or group cast (multicast)

Note that ACK may be called positive acknowledgement and NACK may be called negative acknowledgement. HARQ may be called automatic retransmission request.

Enabling/Disabling Option 1 or Option 2 may be either:
RRC and Downlink Control Information (DCI)
RRC only

In addition, the following is expected for semi-persistent scheduling (SPS) for multicast/broadcast PDSCH:
Adopts SPS group-common PDSCH
Multiple SPS group-common PDSCH can be configured for UE capability
HARQ feedback for SPS group-common PDSCH is possible
Activation/deactivation with at least group-common PDCCH is possible

Note that deactivation may be replaced with other synonymous terms such as release. For example, activation may be read as start, start, trigger, etc., and deactivation may be read as end, stop, etc.

SPS is scheduling used as a contrast to dynamic scheduling and may be referred to as semi-fixed, semi-persistent, semi-continuous, etc., and may be interpreted as Configured Scheduling (CS).

Scheduling may be interpreted as the process of allocating resources to transmit data. Dynamic scheduling may be interpreted as the mechanism by which all PDSCH are scheduled by DCI (For example, DCI 1_0, DCI 1_1, or DCI 1_2). SPS may be interpreted as the mechanism by which PDSCH transmissions are scheduled by higher layer signaling, such as RRC messages.

Also, for the physical layer, there may be a scheduling category of time domain scheduling and frequency domain scheduling.

Furthermore, multicast, group cast, broadcast, and MBS may be interchanged. Multicast PDSCH (May include group-common PDSCH and SPS group-common PDSCH) and PDSCH scrambled by group common RNTI (may be called G-RNTI) may be interchanged.

In addition, data and packet terms may be interchanged and may be interpreted as synonymous with terms such as signal, data unit, etc. and transmission, reception, transmission and delivery may be interchanged.

### (2) Function Block Configuration of Radio Communication System

Next, a functional block configuration of the radio communication system 10 will be described. Specifically, a functional block configuration of the gNB100 and the UE200 will be described.

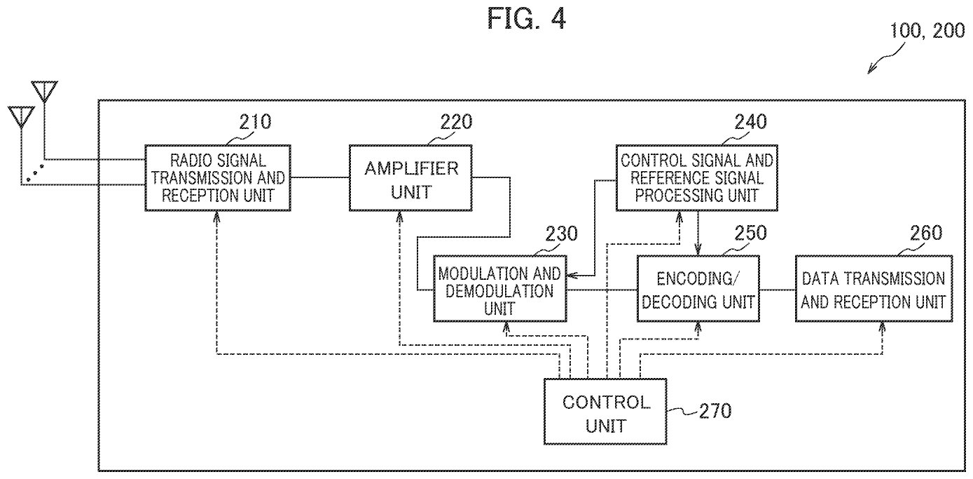

FIG. 4 is a functional block diagram of the gNB100 and the UE200. The UE200 will be described below. As shown in FIG. 4, the UE200 includes a radio signal transmission and reception unit 210, an amplifier unit 220, a modulation and demodulation unit 230, a control signal and reference signal processing unit 240, an encoding/decoding unit 250, a data transmission and reception unit 260, and a control unit 270.

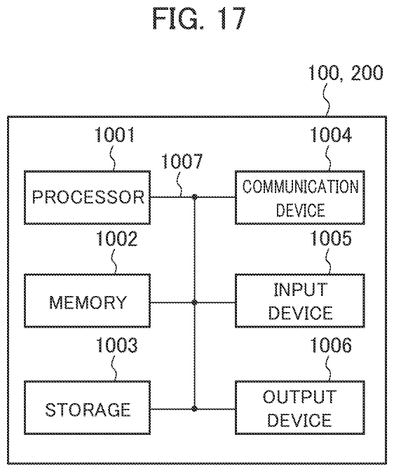

Note that in FIG. 4, only the main functional blocks related to the description of the embodiment are shown, and the UE200 includes other functional blocks (For example, the power supply unit). FIG. 4 also shows the functional block configuration of the UE200 (gNB100), and refer to FIG. 17 for the hardware configuration.

The radio signal transmission and reception unit 210 transmits and receives radio signals in accordance with the NR. the radio signal transmission and reception unit 210 corresponds to a Massive MIMO, a CA using a plurality of CCs bundled together, and a DC that simultaneously communicates between a UE and each of two NG-RAN Nodes.

The radio signal transmission and reception unit 210 also supports MBS and can receive a downlink channel common to a group of terminals in data distribution for a plurality of UE200s.

The radio signal transmission and reception unit 210 can receive a downlink data channel common to a group of terminals (PDSCH), specifically, a group-common PDSCH (which may include an SPS group-common PDSCH). The radio signal transmission and reception unit 210 can also receive a downlink control channel common to a group of terminals, specifically, a group-common PDCCH.

The amplifier unit 220 is configured by a PA (Power Amplifier)/LNA (Low Noise Amplifier) or the like. The amplifier unit 220 amplifies the signal output from the modulation and demodulation unit 230 to a predetermined power level. The amplifier unit 220 amplifies the RF signal output from the radio signal transmission and reception unit 210.

The modulation and demodulation unit 230 performs data modulation/demodulation, transmission power setting, resource block allocation, etc. for each predetermined communication destination (gNB100, etc.). In the modulation and demodulation unit 230, Cyclic Prefix-Orthogonal Frequency Division Multiplexing (CP-OFDM)/Discrete Fourier Transform-Spread (DFT-S-OFDM) may be applied. DFT-S-OFDM may be used not only for uplink (UL) but also for downlink (DL).

The control signal and reference signal processing unit 240 performs processing related to various control signals transmitted and received by the UE200 and various reference signals transmitted and received by the UE200.

Specifically, the control signal and reference signal processing unit 240 receives various control signals transmitted from the gNB100 via a predetermined control channel, for example, a radio resource control layer (RRC) control signal. The control signal and reference signal processing unit 240 also transmits various control signals to the gNB100 via a predetermined control channel.

The control signal and reference signal processing unit 240 executes processing using a reference signal (RS) such as a demodulation reference signal (DMRS), a CSI-RS (Channel State Information-Reference Signal), and a tracking reference signal (TRS).

The DMRS is a reference signal (pilot signal) known between a base station and a terminal for each terminal to estimate a fading channel used for data demodulation. The CSI-RS is a periodic reference signal used to estimate Channel State Information (CSI).

Like the CSI-RS, the TRS is a periodic reference signal and may correspond to the NZP (Non Zero power) CSI-RS. In this embodiment, the TRS may be interpreted as synonymous with the CSI-RS and may be interchanged.

The RS in the downlink (DL) direction may also be referred to as the DL-RS. The DL-RS may include at least one of DMRS (for PDSCH/PDCCH), CSI-RS or TRS. In addition, in a broad sense, the DL-RS may include SSB.

The control signal and reference signal processing unit 240 may receive a plurality of such DL-RSs. For example, the control signal and reference signal processing unit 240 may receive a first downlink reference signal (DL-RS #1) and a second downlink reference signal (DL-RS #2). In this embodiment, the control signal and reference signal processing unit 240 may constitute a reception unit.

Note that the control signal and reference signal processing unit 240 may receive more DL-RS than only DL-RS #1 and DL-RS #2. The control signal and reference signal processing unit 240 may receive the DL-RS before the RRC connection is established (before the RRC connection) or after the RRC connection is established (after the RRC connection). Alternatively, the control signal and reference signal processing unit 240 may receive the DL-RS before and after the RRC connection is established.

The control signal and reference signal processing unit 240 may receive information indicating at least one of the resources of the DL-RS #1 and the DL-RS #2 in a state where the connection at a specific layer such as the RRC is not established. Specifically, the control signal and reference signal processing unit 240 may receive at least one of the resource candidates of the DL-RS #1 and the DL-RS #2. The reception of resource candidates may be achieved by signaling in the RRC or by signaling in a lower layer (For example, DCI).

A resource candidate is a radio resource (Frequency, time or space) that is a candidate for DL-RS (For example, TRS), and may be configured/specified in plural (For example, 64). The resource candidate may be configured/specified in correspondence with SSB.

Alternatively, the control signal and reference signal processing unit 240 may receive specific radio resource and/or QCL information rather than the resource candidate. For example, the control signal and reference signal processing unit 240 may receive information indicating the resource of the DL-RS (For example, TRS) selected by the network (gNB100). The control signal and reference signal processing unit 240 may also receive QCL information of the DL-RS, for example, TCI state or beam BM information (identification information, etc.).

Such QCL information may be included in system information reported from the network (gNB100). Specifically, QCL information may be included in a Master Information Block (MIB) and/or a System Information Block (SIB). The control signal and reference signal processing unit 240 may receive system information including such QCL information.

In addition to the RS described above, the RS may be a Phase Tracking Reference Signal (PTRS), a Sounding Reference Signal (SRS), and a Positioning Reference Signal (PRS) for position information, which are reference signals for individual terminals for estimating phase noise that is a problem in high frequency bands.

The channels include a control channel and a data channel. The control channels may include PDCCH, PUCCH (Physical Uplink Control Channel), RACH (Random Access Channel, Downlink Control Information (DCI) with Random Access Radio Network Temporary Identifier (RA-RNTI)), and Physical Broadcast Channel (PBCH).

The data channels may include PDSCH, PUSCH (Physical Uplink Shared Channel), and the like. Data may mean data transmitted over a data channel.

The encoding/decoding unit 250 performs data partitioning/concatenation and channel coding/decoding for each predetermined communication destination (gNB100 or other gNB).

Specifically, the encoding/decoding unit 250 divides the data output from the data transmission and reception unit 260 into predetermined sizes and performs channel coding for the divided data. The encoding/decoding unit 250 decodes the data output from the modulation and demodulation unit 230 and concatenates the decoded data.

The data transmission and reception unit 260 transmits and receives the protocol data unit (PDU) and the service data unit (SDU). Specifically, the data transmission and reception unit 260 performs assembly/disassembly of the PDU/SDU in a plurality of layers (Media access control layer (MAC), radio link control layer (RLC), packet data convergence protocol layer (PDCP), etc.). The data transmission and reception unit 260 also performs data error correction and retransmission control based on the hybrid automatic repeat request (ARQ).

The control unit 270 controls each functional block constituting the UE200. In particular, in the present embodiment, the control unit 270 executes control on pseudo collocation (QCL) such as reference signal (DL-RS) and synchronization signal block (SSB) in the DL direction.

Specifically, the control unit 270 can execute control on the QCL of multiple types of DL-RS. As described above, the DL-RS may include DMRS (for PDSCH/PDCCH), CSI-RS, and TRS, and the control unit 270 may assume the QCL of these multiple types of DL-RS to be received at the same time according to predetermined conditions (standards).

For example, the control unit 270 may execute such an assumption of the QCL in a state where no connection is established at a specific layer such as the RRC. The state where no connection is established at the layer may include a state where a connection is established (configured) or a state where a connection is once established but is inactive except for some configurations.

In the case of RRC, it may include an RRC idle state or an RRC inactive state. RRC inactive may be interpreted as a state in which all RRC configurations have not been released, as in RRC idle, and some configurations have been retained. It is not necessarily limited to RRC, but may be based on whether connections, channels, bearers, and the like are set in other layers.

When the control unit 270 receives a DL-RS, for example, DL-RS #1 (first downlink reference signal) in a state in which no connection is established in a specific layer, it may assume that DL-RS #1 is a QCL with another DL-RS, for example, DL-RS #2 (second downlink reference signal).

Here, DL-RS #1 may be, for example, a DMRS for PDSCH/PDCCH or a TRS/CSI-RS, and DL-RS #2 may be a DL-RS other than an SSB (such as a TRS/CSI-RS).

The control unit 270 may attempt to receive DL-RS #1 (or vice versa) using QCL information (such as TCI state) obtained by measurement of DL-RS #2.

The control unit 270 may also perform control on the QCL of the DL-RS in the MBS, that is, in data delivery to a plurality of UEs 200.

For example, the control unit 270 may assume that the gNB100 repeatedly transmits a plurality of PDSCH/PDCCH at the MBS of the UE200 in the RRC idle state. Specifically, the control unit 270 may assume that the PDSCH/PDCCH is transmitted over a plurality of PDSCH/PDCCH occasions.

Although the gNB100 may transmit (inform) the SSB and may also transmit the PDSCH/PDCCH for MBS (MBS PDSCH/PDCCH), the UE200 needs to be able to recognize the TRS/CSI-RS (hereinafter abbreviated as TRS as appropriate) resource corresponding to the SSB of good quality, so the UE200 needs to be informed of at least one of the following:
(i) Correspondence between the SSB/TRS and the MBS PDSCH/PDCCH occasion
(ii) Correspondence between any two of the SSB, the TRS, and the MBS PDSCH/PDCCH

Note that “/” may be interpreted as meaning “or” (hereinafter the same).

In this manner, the control unit 270 may configure the reception of the physical downlink channel (MBS PDSCH/PDCCH) for the MBS based on the correspondence relationship between the physical downlink channel (MBS PDSCH/PDCCH) for the MBS and the synchronization signal block (SSB) or a specific downlink reference signal (TRS, etc.). A more specific operation related to the QCL in the MBS will be described later.

In addition, the gNB100 can perform the control related to the transmission of the DL-RS described above. Specifically, the control signal and reference signal processing unit 240 of the gNB100 can transmit a plurality of DL-RS, for example, DL-RS #1 and DL-RS #2. the control signal and reference signal processing unit 240 of the gNB100 may constitute a transmission unit.

### (3) Operation of Radio Communication System

Next, the operation of the radio communication system 10 will be described. Specifically, the operation related to the assumption of QCL using TRS/CSI-RS before the RRC connection is established (before the RRC connection) will be described.

### (3.1) Assumptions

### (3.1.1) Initial Access Procedure

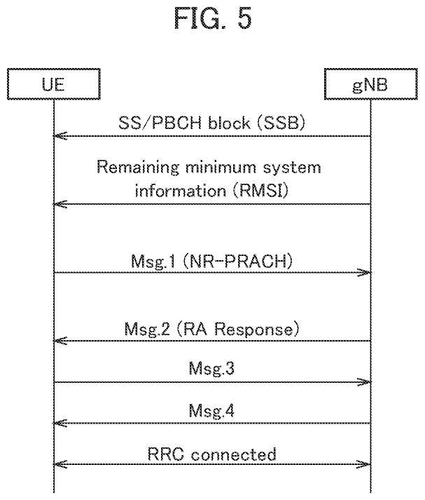

FIG. 5 shows an example sequence of the initial access procedure defined by 3GPP Releases 15 and 16. Specifically, FIG. 5 shows an example sequence following the so-called 4-step random access (RA) procedure. Note that the 2-step RA procedure may be applied.

As shown in FIG. 5, Msg.1˜4 may be transmitted and received between gNB100 and UE200. UE200 may receive SSB and Remaining Minimum System Information (RMSI) before transmitting Msg. 1 (PRACH).

RMSI may be taken to mean System Information Block 1 (SIB1). RMSI may consist of system information that a device (UE200) must know before accessing the system. SIB1 may be broadcast periodically throughout the cell at all times. SIB1 may provide the information required by UE200 to perform the first random access (RA).

When the gNB100 completes the transmission of Msg. 2 (RA Response (RAR)) and Msg. 4 (PDSCH), the RRC connection is established and the state is RRC connected.

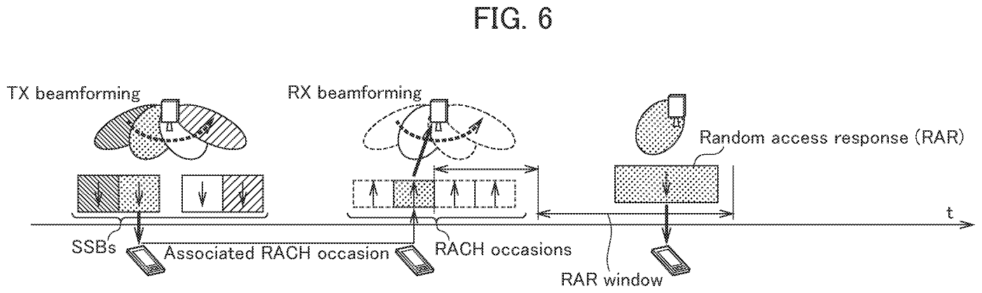

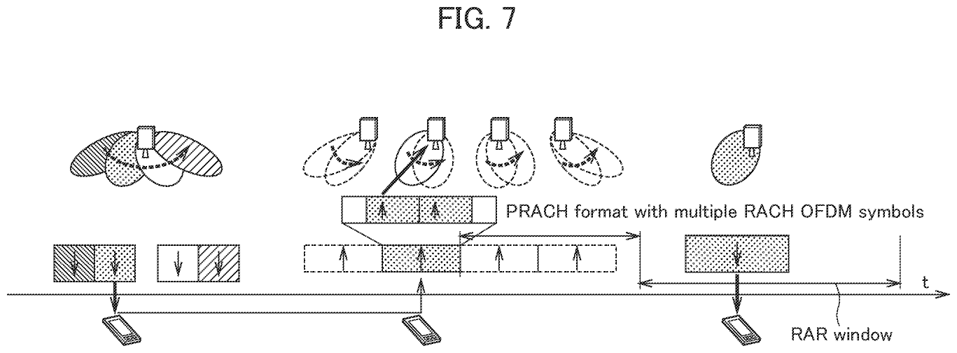

FIG. 6 shows an example of the configuration of the SSB and the RACH Occasion (RO)/RAR window (with beam correspondence). FIG. 7 shows an example of the configuration of the SSB and the RACH Occasion (RO)/RAR window (without beam correspondence).

As shown in FIG. 6, the UE200 may transmit Msg. 1 (PRACH) at the RO associated with the received SSB using a specific beam associated with the RO. Thus, the gNB100 may recognize a beam that the UE200 can receive and transmit RAR using the beam.

Alternatively, as shown in FIG. 7, the UE200 may transmit Msg. 1 using a beam corresponding to the received SSB according to the PRACH format of the plurality of RACH OFDM symbols.

### (3.1.2) Beam Determination Method (Before RRC Connection)

Before RRC connection (May include an RRC idle state or an RRC inactive state, may be referred to as an RRC non-connected state), the DMRS (such as for PDSCH/PDCCH) is specified to be SSB and QCL in 3GPP TS38.214, etc.

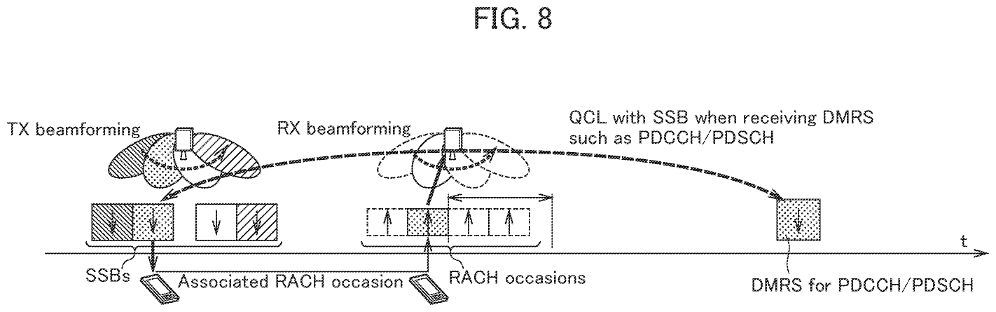

FIG. 8 shows an operation example of beam determination before RRC connection. The UE200 can select the SSB with the maximum received power (corresponding to the best beam) by receiving multiple SSBs. The choice of SSB is left to the implementation of UE200 (That is, you do not necessarily have to select the SSB with the highest received power.).

UE200 may transmit PRACH at the PRACH Occasion corresponding to the most “good” SSB. The gNB100 may also recognize which SSB the UE200 determines to be good (to obtain a common beam understanding between UE and gNB).

The UE200 receives DMRS such as PDSCH/PDCCH, which is defined as SSB and QCL, using QCL information obtained by measuring the SSB with the maximum received power. The gNB100 also transmits DMRS such as PDSCH/PDCCH with the same beam/QCL as the SSB that the UE200 determines to be the best.

In other words, the gNB100 does not tell the UE200 which beam to use, but the UE200 determines which beam to use.

(3.1.3) Beam Determination Method (after RRC Connection)

After RRC connection (RRC connected state), when DMRS such as PDSCH/PDCCH is received, it is specified to follow the TCI state indicated by RRC, MAC CE or DCI.

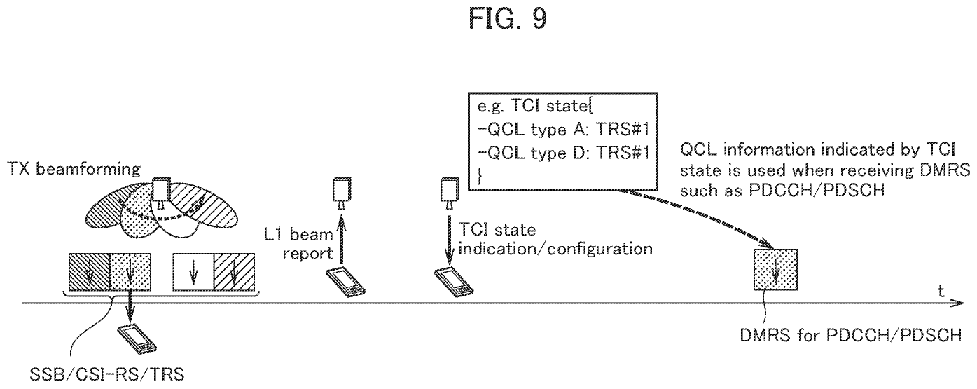

FIG. 9 shows an operation example of beam determination after RRC connection. When receiving SSB/TRS/CSI-RS, UE200 measures RSRP (Reference Signal Received Power) and/or SINR (Signal-to-Interference plus Noise power Ratio) and reports the best (upper) beam to gNB100 (L1-RSRP beam reporting).

Based on the report, gNB100 determines the beam to be assigned to UE200 and notifies UE200 as TCI state. The choice of beam is left to the implementation of gNB100. UE200 receives DMRS such as PDSCH/PDCCH using QCL information of the configured TCI state. Also, gNB100 transmits DMRS such as PDSCH/PDCCH using QCL information of the configured TCI state.

That is, the gNB100 instructs the UE200 which beam to use.

### (3.1.4) Problem

Regarding the QCL assumption described above, if TRS/CSI-RS (hereinafter abbreviated as TRS as appropriate) can be used before RRC connection (for UE in RRC idle state or RRC inactive state), improvement in DMRS reception characteristics of UE200 can be expected.

This is because TRS with larger resource element (RE) density and transmission band in the time/frequency domain can measure the channel state more accurately.

Generally, both SSB and TRS are usually transmitted in the same period (For example, 20 ms), but TRS can also be transmitted in a shorter period than SSB.

However, since the TCI state is dictated by the RRC configuration at the earliest, the DMRS, which is the TRS and QCL, cannot be received (recognized) before the RRC connection.

### (3.2) Example of Operation

In the following example of operation, an example of operation that can solve the problems described above, realize more accurate measurement of the channel state even before RRC connection, and improve DL-RS reception characteristics such as DMRS of UE200 will be described.

### (3.2.1) Example 1

In this example, DL-RS #2 may be used as the QCL source when receiving DL-RS #1 before RRC connection (including RRC idle state or RRC inactive state, hereinafter the same).

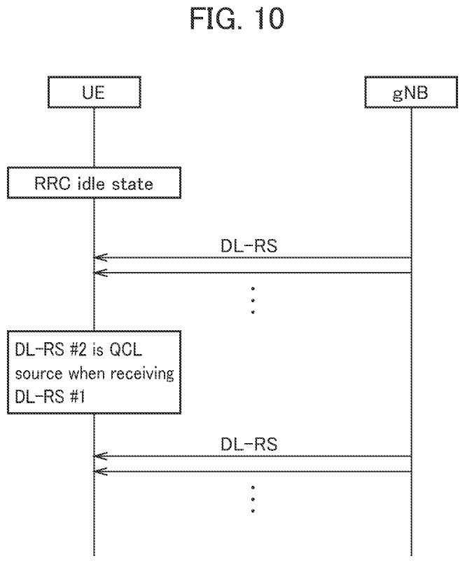

FIG. 10 shows an example of the transmission sequence of the DL-RS according to example 1. As shown in FIG. 10, the UE200 may repeatedly receive a plurality of types of DL-RS (DL-RS #1, #2) before RRC connection (Here, the RRC idle state).

The UE200 may use the DL-RS #2 as the QCL source when receiving the DL-RS #1. In other words, it may be assumed that the DL-RS #1 is QCLed with the DL-RS #2.

Here, the DL-RS #1 may include at least one of DMRS such as PDSCH/PDCCH or DL-RS such as TRS/CSI-RS. In particular, it is preferable that the DMRS such as PDSCH/PDCCH for UE in RRC idle state or RRC inactive state is QCL with TRS or the like. DL-RS #2 may be a DL-RS other than SSB, for example, TRS/CSI-RS.

The UE200 may receive the DL-RS #1 using QCL information obtained by measurement of the DL-RS #2.

### (3.2.2) Example 2

In this example, the resource candidate of DL-RS #2 (For example, TRS/CSI-RS) or the specific resource/QCL information of DL-RS #2 may be notified from the network (gNB100) to the UE200.

### (3.2.2.1) Example 2-1

In this example, specific resource/QCL information of DL-RS #2 (For example, TRS/CSI-RS) need not be reported.

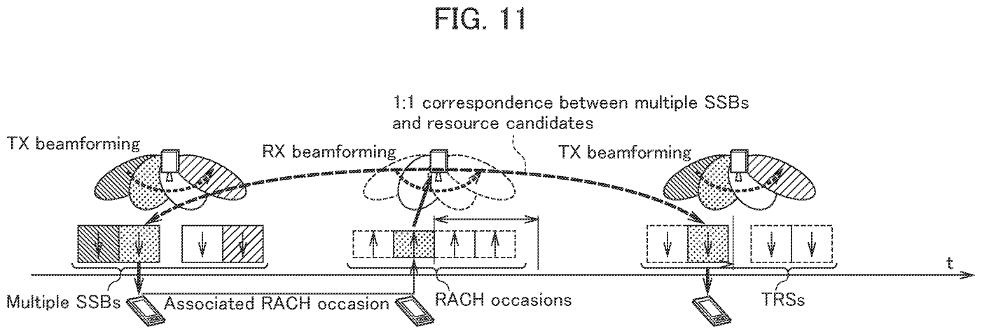

FIG. 11 shows an example of operation of beam determination according to example 2-1. The gNB100 may notify the resource candidate (For example, 64 streets) of the DL-RS #2. For example, the gNB100 may notify the UE200 of a plurality (For example, 64) of candidate TRS resources, and the UE200 may select the TRS resource based on a predetermined method (or by the UE implementation).

TRS resources may include, for example, TRS/CSI-RS resources (such as time/frequency resources), as specified in 3GPP TS38.331.

The UE200 may also notify the gNB100 of information identifying the selected TRS resource. For example, the TRS resource candidate may correspond 1:1 with the SSB, and may notify the gNB100 of the TRS resource selected by the UE200 by transmitting PRACH at the PRACH occasion corresponding to the SSB.

### (3.2.2.2) Example 2-2

In this example, the specific resource/QCL information of DL-RS #2 (For example, TRS/CSI-RS) may be notified from the network (gNB100) to the UE200.

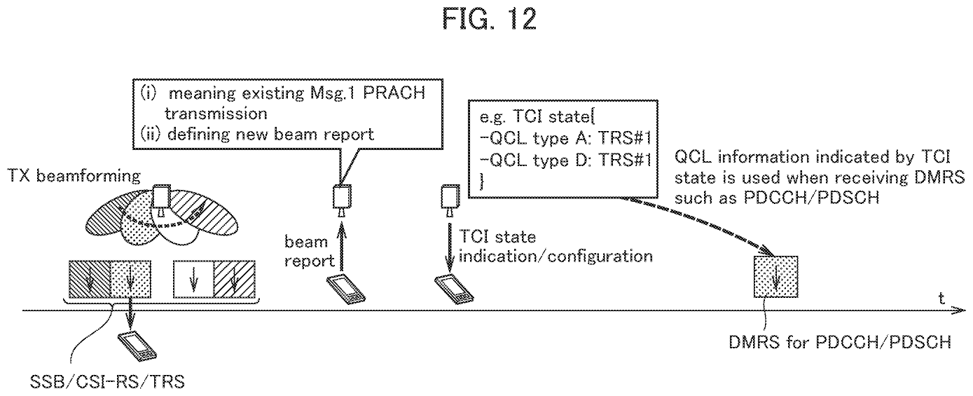

FIG. 12 shows an operation example of beam determination according to the example 2-2. The gNB100 may select a TRS resource and notify the UE200 of the selected TRS resource.

The TRS resource may include a TRS/CSI-RS resource (such as a time/frequency resource), as specified, for example, in 3GPP TS38.331, as in Example 2-1.

The information to be notified may also be QCL information of DL-RS #2 as the TCI state (Existing 3GPP provisions configure the TRS/CSI-RS resource ID in the TCI state).

Alternatively, the TRS/CSI-RS resources (time/frequency resources, etc.) may be notified not as the TCI state but as “QCL RS information,” for example.

The Beam report may also refer to the PRACH transmission of Msg.1 (see FIG. 5) (In other words, an implied report). Alternatively, a new Beam report may be specified and the Beam report may be explicitly reported to gNB100 using, for example, a MAC CE as part of Msg.3.

### (3.2.3) Example 3

This example relates to the assumption of QCL in MBS. In 3GPP, MBS is considered to distribute downstream data to UE200 in RRC idle or RRC inactive state. In such MBS, QCL assumption using TRS/CSI-RS may also be applied to a plurality of UE200 before RRC connection, that is, in RRC idle or RRC inactive state.

Here, before RRC connection may be more specifically limited to (i) before PRACH transmission, (ii) from PRACH transmission to completion of initial access (RA procedure), or may include both (i) and (ii). Alternatively, it may be limited to (ii).

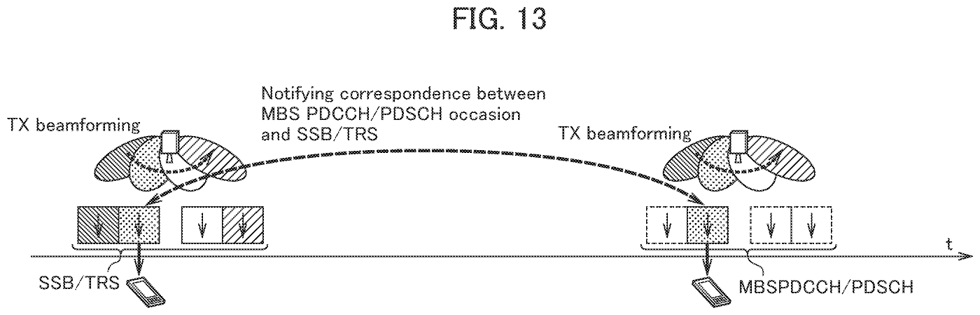

FIG. 13 shows an operation example of beam determination according to operation example 3. In the MBS for the UE in the RRC idle state, the gNB100 may transmit (may transmit repeatedly) PDSCH/PDCCH in a plurality of PDSCH/PDCCH Occasions.

Note that in the case of the MBS, the gNB100 does not necessarily recognize the SSB/beam having good reception in the UE200.

The gNB100 may report the SSB and may also report the PDSCH/PDCCH for the MBS. In this case, only the UE200 needs to know the TRS resource corresponding to the “good” SSB. Thus, the UE200 needs to be informed of at least one of the following:
(i) Correspondence between the SSB/TRS and the MBS PDSCH/PDCCH occasion
(ii) Correspondence between any two of the SSB, the TRS, and the MBS PDSCH/PDCCH

(i) or (ii) is notified to the UE200, the TRS can be used as the QCL source even before the PRACH transmission of the operation example 2-1.

The UE200 may determine the best SSB/TRS resource by measuring the SSB/TRS and receive the PDSCH/PDCCH for the MBS using the resource as QCL information.

The correspondence between (i) and (ii) described above may be communicated, for example, by system information (which may be an MBS-specific SIB) or as part of the system information (see Example 4).

The correspondence may also be communicated as part of the information communicated for the PDSCH/PDCCH of the MBS for UE in the RRC idle or RRC inactive state.

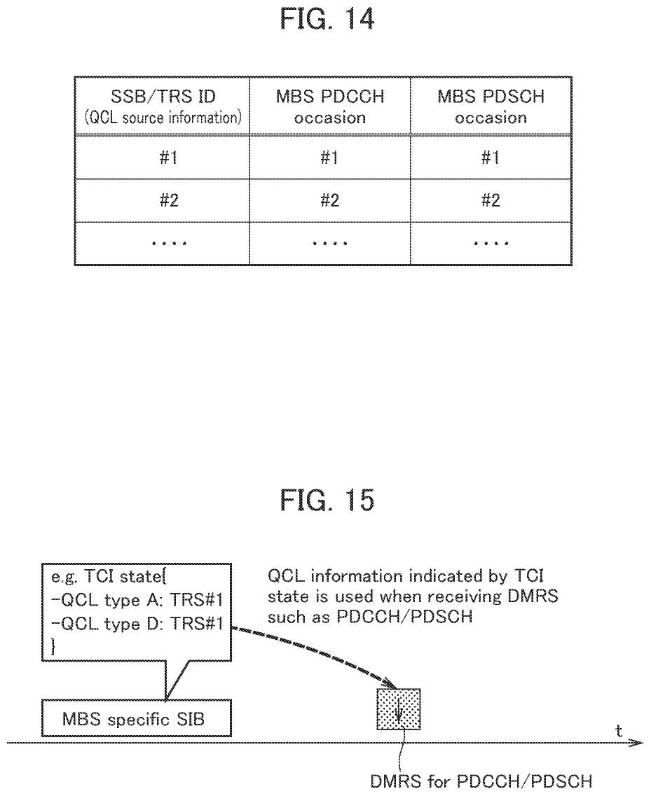

FIG. 14 shows an example of the correspondence between the SSB/TRS and the MBS PDSCH/PDCCH Occasion for operation example 3.

The SSB/TRS ID corresponding to each MBS PDSCH/PDCCH Occasion shown in FIG. 14 may be read as the QCL source corresponding to each MBS PDSCH/PDCCH Occasion, or may be read as the TCI state corresponding to each MBS PDSCH/PDCCH Occasion.

In this case, the TCI state ID may be notified and the SSB/TRS ID to be the QCL source in the TCI state may be notified. The TRS may be a TRS used for MTCH (Multicast Traffic Channel) reception or a periodic TRS.

The UE200 may operate in the order of SSB reception, SSB and QCL PDSCH (SIB (Multicast Control Channel)) reception, and TRS-based PDSCH (MTCH) reception.

The MTCH and MCCH may be interpreted as a type of logic channel for MBS. Control information for MTCH reception may be transmitted by the MCCH. When the control information of the MCCH is changed, the MCCH change notification is transmitted (For example, use the fields contained in RNTI to scramble CRC for DCI or DCI to schedule MCCH), and the UE200 can recognize the change of the control information by receiving the MCCH change notification.

When receiving the MTCH, the UE200 may not use the information based on the TRS received before the MCCH change notification, but may receive the MTCH based on the QCL with the TRS received after the MCCH change notification, or may receive the MTCH assuming that it is an SSB and a QCL. In terms of the physical layer, the MBS PDSCH to which the MTCH is assigned and the PDCCH to which the MBS PDSCH is scheduled may be interpreted as assuming the QCL in this way.

The UE200 may execute such an operation regardless of whether or not the configuration pertaining to the TRS has been changed, or may execute such an operation only when the configuration pertaining to the TRS has been changed.

The UE capability pertaining to TRS reception in the MBS (For example, MTCH) may be at least one of the following.
Capability pertaining to TRS availability
Capability pertaining to TRS availability
Same capability for RRC idle or RRC inactive and RRC connected state

Also, the (may be rephrased as supporting reception or reporting the capability) UE200 that is TRS-enabled or TRS-receivable may receive the MBS PDSCH/PDCCH (For example, MTCH) based on the TRS.

On the other hand, the UE200 that is TRS-inoperable or TRS-receivable may receive the MBS PDSCH/PDCCH (For example, MTCH) based on the SSB that becomes the QCL. Alternatively, the UE200 may not receive the MBS PDSCH/PDCCH. The reception operation may be limited to the case where the MCCH notifies the TRS.

### (3.2.4) Example 4

In this example, the TCI state/QCL information may be instructed to the UE200. Specifically, the TCI state/QCL information described in the example 2 may be instructed to the UE200 as follows.

FIG. 15 shows an instruction example of the TCI state/QCL information according to the operation example 4. As shown in FIG. 15, in the MBS for UE in the RRC idle state or the RRC inactive state, the TCI state/QCL information may be indicated in the MIB/SIB (which may be MBS specific).

The TCI state/QCL information may be indicated in Msg. 2 (see FIG. 5) or RAR UL grant (Msg.3 schedule information). The correspondence relationship between the SSB/TRS described in operation example 3 and the MBS PDSCH/PDCCH occasion may also be indicated to UE200 by the same mechanism.

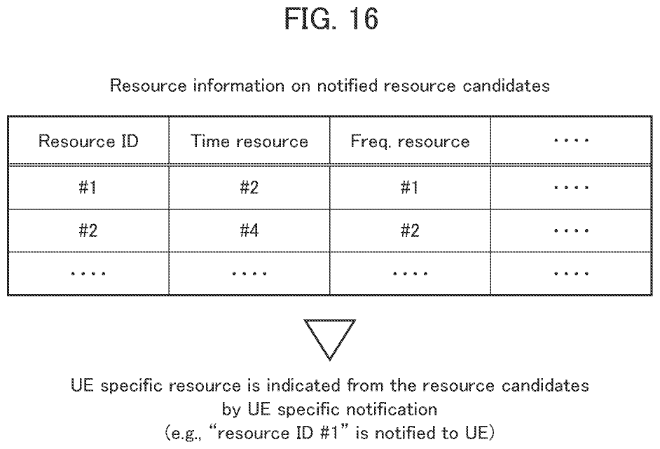

FIG. 16 shows an example of a resource candidate according to operation example 4. The resource candidate information shown in FIG. 16 may be notified of a resource candidate of TRS/CSI-RS by notification information (or multicast/broadcast transmission for a plurality of UEs), and any resource candidate may be selected by UE individual information.

Specifically, as shown in FIG. 16, the UE individual resource may be indicated from the resource candidate by individual notification to the UE200 (For example, “resource ID #1” information is reported to a specific UE200).

### (4) Operational Effects

According to the above-described embodiment, the following effects can be obtained. Specifically, when the UE200 receives a DL-RS, e.g., DL-RS #1 (first downlink reference signal) in a state in which a connection at a specific layer such as an RRC is not established, it may be assumed that the DL-RS #1 is a QCL with another DL-RS, e.g., DL-RS #2 (second downlink reference signal).

Since the DL-RS may include a TRS/CSI-RS, the UE200 may achieve more accurate measurement of the channel state even before the RRC connection. This can be expected to improve the DL-RS of the UE200, especially the DMRS reception characteristics.

In this embodiment, the UE200 may receive information indicating at least one of the resources of the DL-RS #1 and the DL-RS #2 in a state where no connection is established at a specific layer such as the RRC. Therefore, a more accurate measurement of the channel state can be realized based on the resource information even before the RRC connection.

In the present embodiment, the UE200 may configure the reception of the physical downlink channel (MBS PDSCH/PDCCH) for the MBS based on the correspondence relationship between the physical downlink channel (MBS PDSCH/PDCCH) for the MBS and a synchronization signal block (SSB) or a specific downlink reference signal (TRS, etc.) in the MBS. Therefore, the MBS can achieve more accurate measurement of the channel state based on the correspondence relationship even before the RRC connection.

In this embodiment, the UE200 may receive system information including the information of the QCL. Therefore, more accurate measurement of the channel state can be realized based on the system information even before the RRC connection.

### (5) Other Embodiments

Although the embodiments have been described above, they are not limited to the description of the embodiments, and it is obvious to those skilled in the art that various modifications and improvements can be made.

For example, in the above-described embodiment, a term such as DL-RS was used as the reference signal (RS) of the DL, but a signal of another name (Control signals, pilot signals, etc.) may be used if it is a signal in the DL direction and is applicable to the QCL assumption.

In the above-described embodiment, although the operation example 3 is intended for the MBS, the application of the other operation examples to the MBS is not necessarily denied. In addition, the above-described operation examples may be combined and applied in combination as long as there is no conflict.

In the foregoing description, configure, activate, update, indicate, enable, specify, and select may be interchanged. Similarly, link, associate, correspond, and map may be interchanged, and allocate, assign, monitor, and map may be interchanged.

In addition, specific, dedicated, UE-specific, and UE-specific may be interchanged. Similarly, common, shared, group-common, UE-common, and UE-shared may be interchanged.

In the present disclosure, terms such as “precoding,” “precoder,” “weight,” “quasi-co-location (QCL),” “Transmission Configuration Indication state (TCI state)” “spatial relation,” “spatial domain filter,” “transmit power,” “phase rotation,” “antenna port,” “antenna port group,” “layer,” “number of layers,” “rank,” “resource,” “resource set,” “resource group,” “beam,” “beam width,” “beam angle,” “antenna,” “antenna element,” “panel,” and the like may be used interchangeably.

In addition, the block diagram (FIG. 4) used in the description of the above-described embodiment shows blocks of functional units. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, the functional block (component) that functions transmission is called a transmission unit (transmitting unit) or a transmitter. As described above, the method of realization of both is not particularly limited.

In addition, the gNB100 and UE200 described above may function as computers for processing the radio communication method of the present disclosure. FIG. 17 is a diagram showing an example of a hardware configuration of the device. As shown in FIG. 17, the device may be configured as a computer device including a processor 1001, a memory 1002, a storage 1003, a communication device 1004, an input device 1005, an output device 1006 and a bus 1007.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

Each functional block of the device (see FIG. 4) is realized by any hardware element of the computer device or a combination of the hardware elements.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

Processor 1001, for example, operates an operating system to control the entire computer. Processor 1001 may be configured with a central processing unit (CPU), including interfaces to peripheral devices, controls, computing devices, registers, etc.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), or the like. The memory 1002 may store a program (program code), a software module, or the like capable of executing a method according to an embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Each device, such as the processor 1001 and the memory 1002, is connected by a bus 1007 for communicating information. The bus 1007 may be configured using a single bus or a different bus for each device.

Further, the device is configured to include hardware such as a microprocessor, a digital signal processor (Digital Signal Processor: DSP), Application Specific Integrated Circuit (ASIC), Programmable Logic Device (PLD), and Field Programmable Gate Array (FPGA). Some or all of these functional blocks may be realized by the hardware. For example, the processor 1001 may be implemented by using at least one of these hardware.

Information notification is not limited to the aspects/embodiments described in this disclosure and may be performed using other methods. For example, information notification may be performed by physical layer signaling (e.g., Downlink Control Information (DCI), Uplink Control Information (UCI), higher layer signaling (e.g., RRC signaling, Medium Access Control (MAC) signaling, Notification Information (Master Information Block (MIB), System Information Block (SIB)), other signals, or a combination thereof. RRC signaling may also be referred to as RRC messages, e.g., RRC Connection Setup messages, RRC Connection Reconfiguration messages, etc.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing procedures, sequences, flowcharts, etc. of the embodiments/embodiments described in the present disclosure may be rearranged as long as there is no conflict. For example, the method described in the present disclosure presents the elements of the various steps using an exemplary sequence and is not limited to the particular sequence presented.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from a higher layer (or lower layer) to a lower layer (or higher layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each of the embodiments/embodiments described in the present disclosure may be used alone, in combination, or alternatively with execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of the channels and symbols may be a signal (signaling). The signal may also be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS),” “user terminal,” “user equipment (User Equipment: UE),” “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile may be a vehicle (For example, cars, planes, etc.), an unmanned mobile (For example, drones, self-driving cars,), or a robot (manned or unmanned). At least one of a base station and a mobile station can be a device that does not necessarily move during the communication operation. For example, at least one of a base station and a mobile station may be an Internet of Things (IoT) device such as a sensor.

The base station in the present disclosure may be read as a mobile station (user terminal, hereinafter the s same). For example, each aspect/embodiment of the present disclosure may be applied to a configuration in which communication between a base station and a mobile station is replaced by communication between a plurality of mobile stations (For example, it may be called device-to-device (D2D), vehicle-to-everything (V2X), etc.). In this case, the mobile station may have the function of the base station. Further, words such as “up” and “down” may be replaced with words corresponding to communication between terminals (For example, “side”). For example, up channels, down channels, etc. may be replaced with side channels (or side links).

Similarly, mobile stations in the present disclosure may be replaced with base stations. In this case, the base station may have the function of the mobile station. A radio frame may be composed of one or more frames in the time domain. Each frame or frames in the time domain may be referred to as a subframe. A subframe may be further configured by one or more slots in the time domain. Subframes may be of a fixed time length (For example, 1 ms) independent of numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. PDSCH (or PUSCH) transmitted in units of time greater than the minislot may be referred to as PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one of the subframe and the TTI may be a subframe (1 ms) in the existing LTE, a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. The number of slots (number of minislots) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain. The number of subcarriers included in RB may be, for example, twelve, and the same regardless of the topology. The number of subcarriers included in the RB may be determined based on the neurology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (Sub-Carrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be specified by an index of the RB relative to the common reference point of the carrier. PRB may be defined in BWP and numbered within that BWP.

BWP may include UL BWP (UL BWP) and DL BWP (DL BWP). One or a plurality of BWPs may be configured in one carrier for the UE.

At least one of the configured BWPs may be active, and the UE may not expect to transmit and receive certain signals/channels outside the active BWP. Note that “cell,” “carrier,” and the like in this disclosure may be read as “BWP.”

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected,” “coupled,” or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access.” In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

Any reference to an element using a designation such as “first,” “second,” and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include,” “including,” and variants thereof are intended to be inclusive in a manner similar to the term “comprising.” Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining,” “judging” and “deciding” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. In other words, “judgment” and “decision” may include regarding some action as “judgment” and “decision.” Moreover, “judgment (decision)” may be read as “assuming,” “expecting,” “considering,” and the like.

In the present disclosure, the term “A and B are different” may mean “A and B are different from each other.” It should be noted that the term may mean “A and B are each different from C.” Terms such as “leave,” “coupled,” or the like may also be interpreted in the same manner as “different.”

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 radio communication system
20 NG-RAN
100 gNB
200 UE
210 radio signal transmission and reception unit
220 amplifier unit
230 modulation and demodulation unit
240 control signal and reference signal processing unit
250 encoding/decoding unit
260 data transmission and reception unit
270 control unit
1001 processor
1002 memory
1003 storage
1004 communication device
1005 input device
1006 output device
1007 bus

1. A terminal comprising:
a reception unit that receives a first downlink reference signal and a second downlink reference signal; and
a control unit that assumes that the first downlink reference signal is a quasi-colocation with the second downlink reference signal when receiving the first downlink reference signal in a state in which a connection at a given layer is not established.

2. The terminal according to claim 1, wherein the reception unit receives information indicating a resource of at least one of the first downlink reference signal and the second downlink reference signal in a state where no connection is established at the given layer.

3. The terminal according to claim 1, wherein the control unit configures reception of a physical downlink channel based on a relationship between the physical downlink channel for data distribution and a synchronous signal block or a given downlink reference signal in data distribution for a plurality of terminals.

4. The terminal of claim 1, wherein the reception unit receives system information including information on the quasi-colocation.

5. A radio communication system comprising a radio base station and a terminal, wherein:
the radio base station comprises a transmission unit that transmits a first downlink reference signal and a second downlink reference signal;
the terminal comprises:
a reception unit that receives the first downlink reference signal and the second downlink reference signal; and
a control unit that assumes that the first downlink reference signal is a quasi-colocation with the second downlink reference signal when receiving the first downlink reference signal in a state in which a connection at a given layer is not established.

6. A radio communication method comprising the steps of:
receiving at a terminal a first downlink reference signal and a second downlink reference signal; and
assuming at the terminal that the first downlink reference signal is a quasi-colocation with the second downlink reference signal when receiving the first downlink reference signal in a state in which a connection at a given layer is not established.
